(19) United States
(12) Patent Application Publication
(10) Pub. No.: US 2009/0043549 A1
(43) Pub. Date: Feb. 12, 2009

(54) METHODS, APPARATUS, AND PRODUCTS FOR SEISMIC RAY TRACING

(76) Inventor: Chengbin Peng, Sugar Land, TX (US)

Correspondence Address: GILBRETH & ASSOCIATES, P.C., PO BOX 2428, BELLAIRE, TX, 77402-2428, US

(21) Appl. No.: 11/836,130

(22) Filed: Aug. 8, 2007

(51) Int. Cl. G06G 7/48

(52) U.S. Cl. 703/6

(57) ABSTRACT

A computer implemented method for processing prestack seismic data representative of a subterrean contained in a model. The model may include a regular 3-D grid representative of the subterrean; attributes defined at each grid field; and at least one surface or body defined within the grid across which attributes are discontinuous and are not to be smoothed. The method may include ray tracing by solving kinematic or dynamic ray equations for the model in the grid where the interval velocities are not discontinuous, and by applying a refraction rule across the at least one surface or body.

### BACKGROUND

1. Field of the Invention

The present invention relates to methods, apparatus, and products relating to seismic data, seismic data collection, seismic exploration, seismic processing, and seismic interpretation. In another aspect, the present invention relates to methods, apparatus, and products for migrating and modeling seismic wave information. In even another aspect, the present invention relates to methods, apparatus, and products for migrating and modeling seismic wave information and including the processes for 3D ray tracing in a complex velocity model.

2. Description of the Related Art

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One goal of seismic imaging is to obtain accurate subsurface definitions in support of exploration, appraisal and development of oil and gas resources. Recorded seismic information is manipulated for the purpose of producing migrated sections that depict the proper spatial locations of subsurface reflectors. These spatial locations of subsurface reflectors are used in the process of drilling for oil and gas.

Many conventional time migration programs operate on hyperbolic assumptions of seismic diffraction to focus seismic energy to subsurface locations. In most instances, accurate 3D ray tracing is not needed since the velocity model is assumed to be simple. Some time migration methods may not accurately account for rapid lateral velocity variations in seismic waves, and therefore produce poor image results when the earth's crust is indeed highly variable. Hence the need for depth migration.

Depth migration methods require an accurate 3D representation of subsurface velocities since the methods are more sensitive to accuracy in the velocity model. When actual geological conditions are so complex such that either a good velocity model to represent the complexity cannot be derived, or the complexity that exists because of inaccuracies of the velocity representation and of the 3D ray tracing program cannot be accurately honored, depth migration programs are likely to yield poor results.

Most depth migration programs require accurate 3D representations of the subsurface velocity model. For Kirchhoff prestack depth migrations and beam-based prestack depth migrations (including Gaussian beam and Parsimonious migration), accurate 3D ray tracing is also needed.

Beam based depth migration is much faster than Kirchhoff depth migration, and Kirchhoff prestack depth migration is very much faster than wave equation prestack depth migration. Wave equation prestack depth migration also suffers strong dip limitations when lateral velocity variations are strong. For iterative model building work or for quick turnaround imaging, either Kirchhoff depth migration or beam-based depth migration is typically used.

Any proposed model will need to solve one or more of the following typical problems encountered in the seismic processing environment: (1) velocity aliasing at sharp discontinuities caused by grid representation; (2) poorly honoring 3D interpretations at sharp velocity boundaries; (3) large physical size of a 3D gridded velocity model needed to accurately represent a velocity model (5-10 Gigabytes or larger); and (4) loss of ray tracing accuracy at sharp velocity discontinuity.

Some embodiments of the present invention may help solve these kinds of problems.

### SUMMARY OF THE INVENTION

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

According to one embodiment of the present invention, there is provided a data structure embedded in computer readable media, for modeling prestack seismic data representative of a subterrean. The structure may include grid fields containing data indicative of regular 3-D grid representative of the subterrean. The structure may also include attribute fields, associated with the grid fields, and containing data indicative of at least one attribute at each grid field. The structure may also include surface fields, wherein the surface fields define a surface within the grid across which attributes are discontinuous and are not to be smoothed.

According to another embodiment of the present invention, there is provided a computer implemented method for processing prestack seismic data representative of a subterrean contained in a model. The model may include a regular 3-D grid representative of the subterrean. The model may also include attributes defined at each grid field. The model may also include at least one surface defined within the grid across which attributes are discontinuous and are not to be smoothed. The method may include ray tracing by solving kinematic or dynamic ray equations for the model in the grid where the interval velocities are not discontinuous, and by applying a refraction rule across the at least one surface.

According to even another embodiment of the present invention, there is provided a data structure embedded in computer readable media, for modeling prestack seismic data representative of a subterrean. The structure may include grid fields containing data indicative of regular 3-D grid representative of the subterrean. The structure may also include attribute fields, associated with the grid fields, and containing data indicative of at least one attribute at each grid field. The model may also include body fields, wherein the body fields define a body within certain grids. The model may also include override fields, associated with the body fields, containing data indicative of at least one attribute at those certain grids.

According to still another embodiment of the present invention, there is provided a computer implemented method for processing prestack seismic data representative of a subterrean contained in a model. The model may include a regular 3-D grid representative of the subterrean. The model may also include attributes defined at each grid field. The model may also include a body defined within the grid. The model may also include override attributes defined for the body. The method include ray tracing by solving kinematic or dynamic ray equations for the model in the grid where the interval velocities are not discontinuous, by applying a refraction rule at the body, and utilizing the override attributes within the body.

These and other embodiments of the present invention will become apparent upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 shows an example of upgoing rays traced from a diffractor to the earth's surface, using the model of the present invention that does not contain any triangulated surfaces or closed bodies.

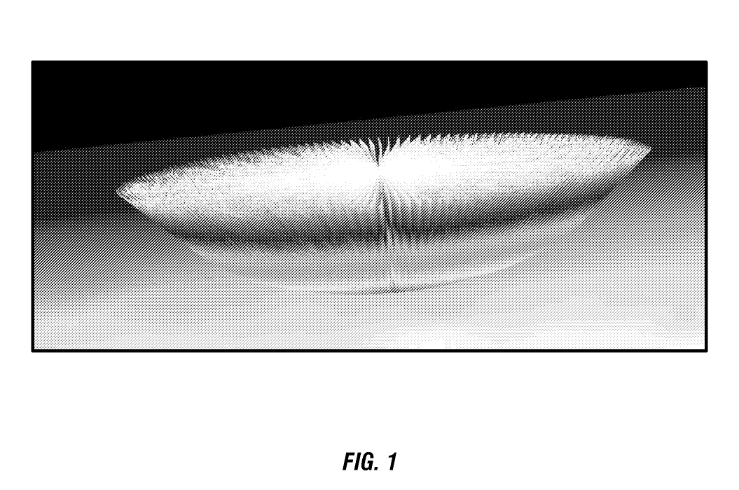

FIG. 2 shows an example of rays traced between the earth's surface and a reflector specified as a triangulated surface in the model of the present invention.

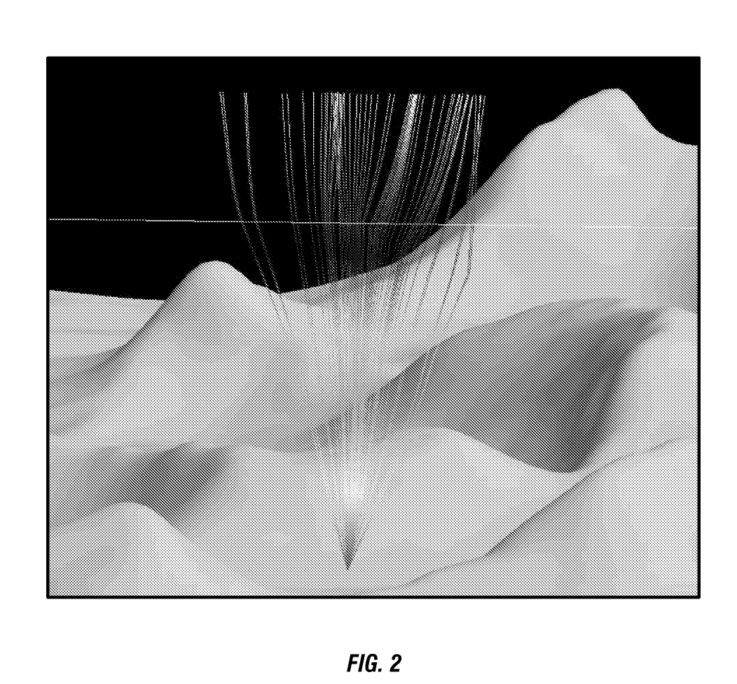

### DETAILED DESCRIPTION OF THE INVENTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

Many of the embodiments of the present invention are illustrated by use of the commercially available GOCAD® geological modeling software, available from Paradigm Geophysical. Details regarding the GOCAD® geological modeling software may be found in the GOCAD Developer's Guide, at www.earthdecisionsciences.com, both of which are herein incorporated by reference. However, it should be understood that the present invention may be carried out through the use of any suitable geological modeling software, whether commercially available software, proprietary software, or any other software. As non-limiting examples, other geological modeling software include Halliburton's Geoprobe and Landmark software and Schlumberger's Geoquest and Petrel software.

The methods, apparatus, and products of the present invention utilize a novel IHS model for velocity representation and a novel process for 3D ray tracing in complex velocity models. The model may include one or more of the following:
(1) a regular 3D grid of at least one attribute (interval velocities as a non-limiting example) defined at each grid cell,
(2) at every grid cell there is a region flag defined,
(3) there may be a few triangulated surfaces across which smoothing is disallowed,
(4) there may be a few closed bodies to allow override of the velocity property and to allow accurate application of Snell's law during ray tracing,
(5) there may be a few other attributes (such as density, shear velocity, anisotropy parameters) defined at each grid cell, and
(6) velocity control parameters such as amount of smoothing and interpolation method.

The model described above may be referred to herein as a “NexusModel.”

For some embodiments of the model of the invention, the regular 3D grid is typically for defining desired attributes, a non-limiting example would include the background sediment velocities. These attributes may be defined for any portion of a grid cell, a non-limiting example would be at the center of the grid cell. The surfaces and bodies may be defined by triangulated 3D meshes representing sharp velocity or elastic property discontinuities. For some embodiments of the model, they may be floating within the NexusModel.

For some embodiments of the invention, the process for 3D ray tracing in a NexusModel may include one or more of the following:
(1) casting each surface or body inside an invisible cage to subdivide triangles associated with each surface or body,
(2) ray tracing in a NexusModel by solving the kinematic or dynamic ray equations in regions where velocity is continuous,
(3) intersecting a given ray path with every surface and body,
(4) explicitly applying a refraction rule, Snell's law as a non-limiting example, at velocity boundaries represented by triangulated surfaces and bodies, and
(5) in case of dynamic ray tracing, applying continuity constraints of displacement and stress across the boundaries as well.

For some embodiments of the present invention, the model of the present invention may be defined as including one or more of the following:
(1) A regular 3D grid of desired attributes, interval velocities as a non-limiting example, defined at each cell;
(2) Optionally, a region flag at every grid cell;
(3) Optionally, a few triangulated surfaces;
(4) Optionally, a few closed bodies; and/or
(5) Optionally, a few other attributes defined at each grid cell.

In some embodiments of the present invention, a region flag may be used for any one or more of the following:
(1) Analytical definition of velocity at some collection of cells;
(2) Selective smoothing, editing, and manipulation within a region;
(3) Setting up geological constraints in velocity inversion applications; and/or
(4) Other surgical, functional, or inversion purposes.

In some embodiments of the present invention, regions can be ignored altogether. As a non-limiting example, the setting UseRegion=0 may be used to ignore regions. In other embodiments of the present invention a default may be set to use regions. As a non-limiting example, the setting UseRegion=1 may be used to allow regions.

In some embodiments of the present invention, surfaces may be used for any one or more of the following:
(1) Refracting rays across sharp velocity interfaces;
(2) Solving velocity aliasing problem at sharp velocity interfaces; and/or
(3) Cutting a velocity grid into regions, if not done yet.

In some embodiments of the present invention, surfaces can be ignored. As a non-limiting example, the setting UseSurface=0 may be used to ignore surfaces. This may speed up ray tracing. For other embodiments of the present invention, a default may be set to use surfaces. As a non-limiting example, the setting UseSurface=1 may be used to allow surfaces.

In some embodiments of the present invention, bodies may be used for:
(1) Refracting rays across sharp velocity interfaces;
(2) Overwriting velocity and attribute values within the bodies;
(3) Solving velocity aliasing problems at sharp velocity interfaces; and/or
(4) Cutting a velocity grid into regions, if not done yet.

In some embodiments, if present, bodies cannot be ignored.

In some embodiments of the present invention, attributes are used for storing anisotropy parameters and/or elastic parameters. The number of attributes may be set to any desirable number of attributes. For some embodiments, the number of attributes may be set to zero (i.e., only velocity is defined by default).

Some embodiments of the present invention may provide for interpolation of velocity and/or attributes. As a non-limiting example, some embodiments of the present invention may utilize tri-linear interpolation or tri-spline interpolation. As a non-limiting example, in some embodiments, interpolation of velocity and/or attribute may be controlled by the parameter IntMethod, wherein when IntMethod=0 there is tri-linear interpolation (default), and when IntMethod=1 there is tri-spline interpolation.

Some embodiments of the present invention may provide for internal smoothing of velocity and/or attributes. As a non-limiting example, in some embodiments, internal smoothing of velocity and/or attribute may be controlled by the parameter NeedSmooth and PeakFrequency, wherein when NeedSmooth=0 internal smoothing is off, and when NeedSmooth=1 internal smoothing is on (default).

In some embodiments, the PeakFrequency parameter may be used to adaptively compute smoothing length. As a non-limiting example, the default value of PeakFrequency may be set to 25 Hz. While smoothing may be applied at any desirable point in the processing, as a non-limiting example, smoothing, if needed, may be applied prior to interpolation.

In the practice of the present invention, the smoothing length in the ray direction, and the smoothing length in directions perpendicular to ray direction may be set to any desirable length. As a non-limiting example, the smoothing length in the ray direction may be set to one peak wavelength, and the smoothing length in directions perpendicular to ray direction may be set to be larger than the peak wavelength, and as a further non-limiting example, the setting SmoothSize=2 may be utilized to implement this.

In some embodiments, the smoothing parameters are also applicable to the surfaces in the evaluation of surface normal.

The physical storage of the model of the present invention may be accomplished using any suitable storage medium, using any suitable file format. As a non-limiting example, the model of the present invention may be stored as an XML file. XML format is convenient for storing the model, because XML is the industry standard for defining meta data (i.e., data that describes other data). A wealth of free software is publicly available for viewing, editing, and extracting information from XML documents. A non-limiting example of such an XML file is shown in Table 1 as follows:

```
  <?xml version=”1.0” encoding=”ISO-8859-1”?>
  <nexus_hybrid_model xmlns:xsi=
  http://www.w3.org/2001/XMLSchema-instance”
                xsi:noNamespaceSchemaLocation=”nhm.xsd”>
    <!--  name of the velocity model  -->
    <model_name> xxxx_v7 </model_name >
    <!--  velocity voxet must be givenv -->
    <velocity>
      <voxet> /data/xxxx_v7.vo </voxet>
      <volume> vel_v7  </volume>
    </velocity>
    <!--  optional surfaces  -->
    <surfaces>
      <surface use=”true”>  /data/wb.ts </surface>
      <surface use=”false”> /data/faultl.ts </surface>
    </surfaces>
    <!--  optional salt bodies  -->
    <bodies>
      <body overwrite=”true” v0=”14500” kx=”0” ky=”0” kz=”0”>
              /data/mainsalt.ts
      </body>
      <body overwrite=”true” v0=”14500” kx=”0” ky=”0” kz=”0”>
              /data/deepsalt.ts
      </body>
    </bodies>
    <!--  optional attributes  -->
  <attributes>
      <attribute_voxet> /data/test.vo  </attribute_voxet>
```

| | | |
|---|---|---|
| <density> | rho | </density> |
| <delta> | delta | </delta> |
| <eta> | eta | </eta> |
| <vs> | v_shear | </vs> |
| </attributes> | | |

```
  <!-- parameters for velocity model smoothing and interpolation -->
  <parameters>
```

| | | |
|---|---|---|
| <useRegion> | “true” | </useRegion> |
| <useSurface> | “true” | </useSurface> |
| <intMethod> | “spline” | </intMethod> |
| <needSmooth> | “true” | </needSmooth> |
| <peakFreq> | 25 | </peakFreq> |
| <smoothSize> | 2 | </smoothSize> |
| </parameters> | | |

</nexus_hybrid_model>

In some embodiments, by default, when a model is loaded, the Velocity and Region grids may be stored in memory. Also, the surfaces and bodies may also be loaded into memory. All other attributes may be kept on disk and are accessed through a voxet controller.

Certainly, it should be understood that the model can be also used to store other subsurface properties in addition to velocity and/or anisotropy properties.

### EXAMPLES

This non-limiting example is for a project XXXX, a working velocity model that can be used in ray tracing, demigration and remigration. The model name is XXXX_V17_Nexus. The background sedimentary voxet volume is the V17 sediment flood, sampled at every 16th common depth point (CDP) and every 8th Line and at a depth increment of 160 ft. The salt body is the V17 salt: Salt_V17_Final.ts. The velocity in the salt is assigned a constant value of 14850 ft/s. See Table 2 below.

```
<?xml version=“1.0” encoding=“ISO-8859-1” ?>
<nexus_Nexus_model
xmlns:xsi=“http://www.w3.org/2001/XMLSchema-instance”
          xsi:noNamespaceSchemaLocation=“/apps/template/nhm.xsd”>
<model_name> XXXX_V17_Nexus </model_name>
<survey3d> /data/V17_survey.xml </survey3d>
<velocity>
  <voxet> /data/vo_01242006_tiny_vel_16×8_160.vo
  </voxet>
  <volume> vel_17_sedi </volume>
</velocity>
<bodies>
  <body overwrite=“yes” v0=“14850” kx=“0” ky=“0” kz=“0”>
    /data/Salt_V17_Final.ts </body>
</bodies>
<parameters>
```

| | | |
|---|---|---|
| <useRegion> | true | </useRegion> |
| <useSurface> | true | </useSurface> |
| <intMethod> | spline | </intMethod> |
| <needSmooth> | false | </needSmooth> |
| <peakFreq> | 30 | </peakFreq> |
| <smoothSize> | 2 | </smoothSize> |
| <minimum> | 4920.0 | </minimum> |
| <maximum> | 17500.0 | </maximum> |
| </parameters> | | |

</nexus_Nexus_model>

The various methods of the present invention include any one or more or all of the method steps described or implied herein. In further non-limiting embodiments, one or more or all of the steps of any the methods described or implied herein may be described as instructions for execution by an information handling system, and may be stored on one or more computer readable media, transmitted by a propagated signal, or may comprise part of an information handling system.

In other non-limiting embodiments, the computer readable media as described or implied herein may be incorporated into information handling systems.

In even further embodiments, information handling systems are envisioned which include a processor, computer readable media comprising the above described data structures or instructions, wherein the media is accessible by the processor, and wherein the processor may carry out the instructions.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A data structure embedded in computer readable media, for modeling prestack seismic data representative of a subterrean, the structure comprising:
Grid fields containing data indicative of regular 3-D grid representative of the subterrean;
Attribute fields, associated with the grid fields, and containing data indicative of at least one attribute at each grid field; and
Surface fields, wherein the surface fields define a surface within the grid across which attributes are discontinuous and are not to be smoothed.

2. The data structure of claim 1, further comprising:
Flag fields, associated with the grid fields, and containing data indicative of a region flag in each grid cell.

3. The data structure of claim 1, wherein the attribute is selected from the group consisting of anisotropy parameters, elastic parameters, petrophysical parameters, and reservoir property parameters.

4. The data structure of claim 1, wherein the attribute is velocity.

5. The data structure of claim 1, further comprising:
Control fields, associated with the grid fields, and containing data indicative of velocity control parameters for each grid cell.

6. The data structure of claim 1, wherein the surface fields define a closed surface, and the structure further comprises closed surface attribute fields associated with the closed surface.

7. A computer implemented method for processing prestack seismic data representative of a subterrean contained in a model, the model comprising:
A regular 3-D grid representative of the subterrean;
Attributes defined at each grid field; and,
At least one surface defined within the grid across which attributes are discontinuous and are not to be smoothed.
the method comprising:
ray tracing by solving kinematic or dynamic ray equations for the model in the grid where the interval velocities are not discontinuous, and by applying a refraction rule across the at least one surface.

8. The method of claim 7, further comprising:
Executing depth migration on at least a portion of the prestack seismic data.

9. The method of claim 7, wherein the surface is closed and defines a body, and wherein the model further includes override attributes within the body,
the method further comprising:
applying a refraction rule at the closed body and utilizing the override attributes within the body.

10. The method of claim 9, further comprising:
Executing depth migration on at least a portion of the prestack seismic data.

11. A data structure embedded in computer readable media, for modeling prestack seismic data representative of a subterrean, the structure comprising:
Grid fields containing data indicative of regular 3-D grid representative of the subterrean;
Attribute fields, associated with the grid fields, and containing data indicative of at least one attribute at each grid field; and
Body fields, wherein the body fields define a body within certain grids;
Override fields, associated with the body fields, containing data indicative of at least one attribute at those certain grids.

12. The data structure of claim 11, further comprising:
Flag fields, associated with the grid fields, and containing data indicative of a region flag in each grid cell.

13. The data structure of claim 11, wherein the attribute is selected from the group consisting of anisotropy parameters, elastic parameters, petrophysical parameters, and reservoir property parameters.

14. The data structure of claim 11, wherein the attribute is velocity.

15. The data structure of claim 11, further comprising:
Control fields, associated with the grid fields, and containing data indicative of velocity control parameters for each grid cell.

16. A computer implemented method for processing prestack seismic data representative of a subterrean contained in a model, the model comprising:
A regular 3-D grid representative of the subterrean;
Attributes defined at each grid field;
A body defined within the grid; and,
Override attributes defined for the body;.
the method comprising:
ray tracing by solving kinematic or dynamic ray equations for the model in the grid where the interval velocities are not discontinuous, by applying a refraction rule at the body, and utilizing the override attributes within the body.

17. The method of claim 16, further comprising:
Executing depth migration on at least a portion of the prestack seismic data.
